(19) United States
(12) Patent Application Publication
(10) Pub. No.: US 2003/0185148 A1
(43) Pub. Date: Oct. 2, 2003

(54) Spare path design method for communication network

(76) Inventors: Norihiko Shinomiya, Kawasaki (JP); Keiji Miyazaki, Kawasaki (JP)

Correspondence Address: KATTEN MUCHIN ZAVIS ROSENMAN, 575 MADISON AVENUE, NEW YORK, NY, 10022-2585, US

(21) Appl. No.: 10/324,372

(22) Filed: Dec. 20, 2002

(30) Foreign Application Priority Data
Mar. 28, 2002 (JP) 2002-091874

(51) Int. Cl. H04J 1/16

(52) U.S. Cl. 370/216

(57) ABSTRACT

A spare path design method for a communication network in which spare path information is set in each node of the communication network constituted of a plurality of nodes based on a database, a fault notification message including fault location information is transferred from a fault detection node to each node when a link fault or a node fault occurs. The nodes receiving the fault notification message switch the path in parallel. The spare path design method includes comparing the maximum fault notification time among the nodes located on a second spare path with the maximum fault notification time among the nodes located on a first spare path when a resource sharing condition is satisfied; and as a result of the comparison, if the time in the second path is shorter, replacing the spare path by the second spare path to update spare path information stored in the database.

### FIELD OF THE INVENTION

The present invention relates to a spare path design method enabling prompt communication restoration from a communication path fault without increasing spare communication capacity.

### BACKGROUND OF THE INVENTION

With increased variety of services in and expanded demand for the Internet, communication traffic flowing through backbone networks continues to increase drastically. To cope with this situation, implementation of large capacity and high-speed backbone network based on the WDM (wavelength division multiplexing) technique is now in progress.

In addition, optical cross connect (OXC) and optical add-drop multiplexer (OADM) have been developed so as to achieve flexible control and efficient operation of a mesh network employing shared spare wavelength. It is expected to construct a new communication infrastructure and to introduce new services using such equipment.

In a large capacity WDM network, as a lot of services have been introduced, a damage caused by a fault often becomes serious. Therefore, developing a highly sophisticated management system is a key to increase network reliability. In particular, it becomes important to provide a technique for promptly restoring services from a link or a node fault in the optical layer.

The inventors of the present invention et al have been studying a pre-plan type fault restoration method for achieving prompt restoration from a fault in a WDM network (Refer to the paper: “A study on a pre-plan type fault restoration method” by FUJII, Yasuki; MIYAZAKI, Keiji; and ISEDA, Kouhei, IEICE Technical Report TM2000-60, pp.67-72, November 2000.)

In this pre-plan type fault restoration method, a path is switched over in parallel according to spare path information set in each node by notifying fault information from the fault detection node successively to each neighboring node (which is referred to as ‘flooding’) against the nodes in which the spare path information has been set in advance. This enables to shorten time to seek an alternative path (or spare path) dynamically and thus prompt service restoration can be expected.

However, even though parallel switchover becomes possible with this method, there remains a problem that prompt service restoration cannot be achieved when a long time is needed until each node located on a spare path receives the fault information for switchover.

Also, in the conventional spare path design method, it is only aimed to minimize total number of spare wavelengths (resources) in regard to initially designed spare paths.

Considering these problems, the inventors of the present invention et al are further studying another spare path design method for a communication network to decrease the flooding time as well as to minimize the total number of spare wavelengths with the provision of a time limit to fault notification message transfer to each node (disclosed in the official gazette of Japanese Unexamined Patent Publication No. Hei-13-8007, and also in the paper “A study on spare path design method in an optical network considering fault notification time” by SINOMIYA, Norihiko; FUJII, Yasuki; MIYAZAKI, Keiji; and ISEDA, Kouhei, the Third Telecommunication Management Workshop, pp. 127-132, March 2001.)

According to the aforementioned spare path design method, in particular a strict upper limit is prepared against fault restoration time to shorten the flooding time. Namely, in the previous communication network design method, spare communication capacity of communication links was shared among spare communication paths against different faults so that total spare communication capacity of the communication network can be minimized while satisfying an upper time limit in fault notification to each node.

However, this upper time limit requires total spare communication capacity in the entire network greater than that required in the design where no time limit is applied. This is effective in traffic and service, such as voice and SONET (Synchronous Optical Network) client signals, in which priority is given to prompt fault restoration (for example 50 msec).

Meanwhile, when high-speed fault restoration time is not strictly required, as in the case of communication of best effort type (such as IP packet transfer), there is no need to prepare extra spare communication capacity in the entire network by imposing such upper time limit.

### SUMMARY OF THE INVENTION

Accordingly, it is an object of the present invention to provide a spare path design method of a communication network which includes; conducting spare path design so as to minimize total spare communication capacity of the entire network at the time of spare path design employing the pre-plan type fault restoration method; and then seeking a spare path constituted of nodes having shorter arrival time of a fault notification message to update spare path information, thereby enabling to shorten a fault notification time on each spare path without increasing total spare communication capacity obtained by the spare path design in the initial stage.

As a first embodiment of the present invention to solve the aforementioned problem, there is provided a spare path design method for a communication network in which spare path information is set in advance in each node of the communication network constituted of a plurality of nodes based on a database, a fault notification message including fault location information is transferred from a fault detection node to each node in the event of a link or a node fault, and the nodes receiving the fault notification message switch the path in parallel. The spare path design method includes the steps of; selecting a first spare path obtained by an initial design to obtain among nodes located on the first spare path a node having the maximum fault notification time from the fault detection node; seeking a second spare path different from the first spare path; examining whether or not the second spare path can share spare communication resources against other faults, to compare the maximum fault notification time among the nodes located on the second spare path with the maximum fault notification time among the nodes located on the first spare path when the resource sharing condition is satisfied; and, as a result of the comparison, if the time in the second path is shorter, replacing the spare path by the second spare path to update spare path information stored in the database.

As a second embodiment of the present invention, in the first embodiment, a time for completing to transfer fault notification messages from the fault detection node to the entire nodes located on a spare path is calculated by obtaining a transfer time of the fault notification message from the fault detection node to each node and then obtaining the maximum value among the time values calculated for the entire nodes located on the spare path.

As a third embodiment of the present invention, in the first embodiment, the spare path design method further includes the step of; when seeking a second spare path different from the first spare path, omitting the node located on the first spare path having the maximum fault notification time, nodes having longer fault notification time than the maximum fault notification time, and links which are incapable of sharing spare communication resources against other faults.

As a fourth embodiment of the present invention, in the first or third embodiment, the spare path design method includes the step of; when the node located on the first spare path having the maximum fault notification time exists inside a certain isolated domain, seeking another spare path between an entry node and an exit node of the domain which passes through neither the node on the first spare path having the maximum fault notification time, nodes having longer fault notification time than the maximum fault notification time, nor links which are incapable of sharing spare communication resources against other faults.

As a fifth embodiment of the present invention, in the first embodiment, the spare path design method includes the steps of; for a current path (or path in use) newly required to add, setting both the current path required to add and an arbitrary spare path; and thereafter, for the arbitrary spare path, updating to a spare path which is capable of sharing spare communication resources against a different fault and transferring the fault notification message from the fault detection node in a shortened time without increasing spare communication resources.

As a sixth embodiment of the present invention, in the first embodiment, the spare path design method includes the steps of; designing a spare path capable of reducing a certain rate of total spare communication resources against the first spare path previously set; and thereafter, for the spare path reducing the total spare communication resources, updating to a spare path which is capable of sharing spare communication resources against a different fault and transferring the fault notification message from the fault detection node in a shortened time without increasing spare communication resources.

As a seventh embodiment of the present invention, in the first or sixth embodiment, a spare path design for minimizing a spare communication capacity is performed as the initial design.

As an eighth embodiment of the present invention, in the first or fifth embodiment, when setting a strict upper limit to a fault restoration time is required, the design method selects a method including the steps of; seeking a spare path having the minimum transfer time of fault notification message; and then, updating to a spare path which is capable of sharing spare communication resources against a different fault and switching a path within a given upper time limit.

Further scopes and features of the present invention will become more apparent by the following description of the embodiments with the accompanied drawings.

### BRIEF DESCRIPTION OF THE DRAWINGS

FIG. 1 shows a conceptual diagram of a communication network and a network management system incorporating the spare path design method in a communication network according to the present invention.

FIG. 2 shows a drawing illustrating functions of the network management system (NMS).

FIG. 3 shows an exemplary configuration block diagram of a communication node.

FIG. 4 shows a diagram illustrating a detailed configuration of a message controller 102.

FIG. 5 shows an exemplary topology of a communication network as an object of the present invention.

FIG. 6 shows an exemplary data structure of a spare path list (refer to FIG. 2) based on the topology shown in FIG. 5.

FIG. 7 shows a process flow of the spare path design method according to the present invention.

FIG. 8 shows a data structure of a communication node on a spare path and an exemplary data thereof.

FIG. 9 shows an updating method of a spare path shown in FIG. 7.

FIG. 10 shows a design process flowchart specifically illustrating the process shown in FIG. 9.

FIG. 11 shows another embodiment of the present invention illustrating an updating method of a spare path restricted within a sub network

FIG. 12 shows a flowchart illustrating an operation of still another embodiment of the present invention in which the process in case an additional requirement on a current path is issued on demand.

FIG. 13 shows still another embodiment of the present invention.

FIG. 14 shows still another embodiment of the present invention.

FIG. 15 shows a diagram illustrating a method of determining a required fault restoration time of a current path and selecting a design method according to the required restoration time.

### DETAILED DESCRIPTION OF THE PREFERRED EMBODIMENTS

The preferred embodiments of the present invention are described hereinafter referring to the drawings, wherein like numerals or symbols refer to like parts. It is to be noted that the illustrations of the embodiments in the figures aim at better understanding of the present invention and the application of the present invention is not limited to these embodiments.

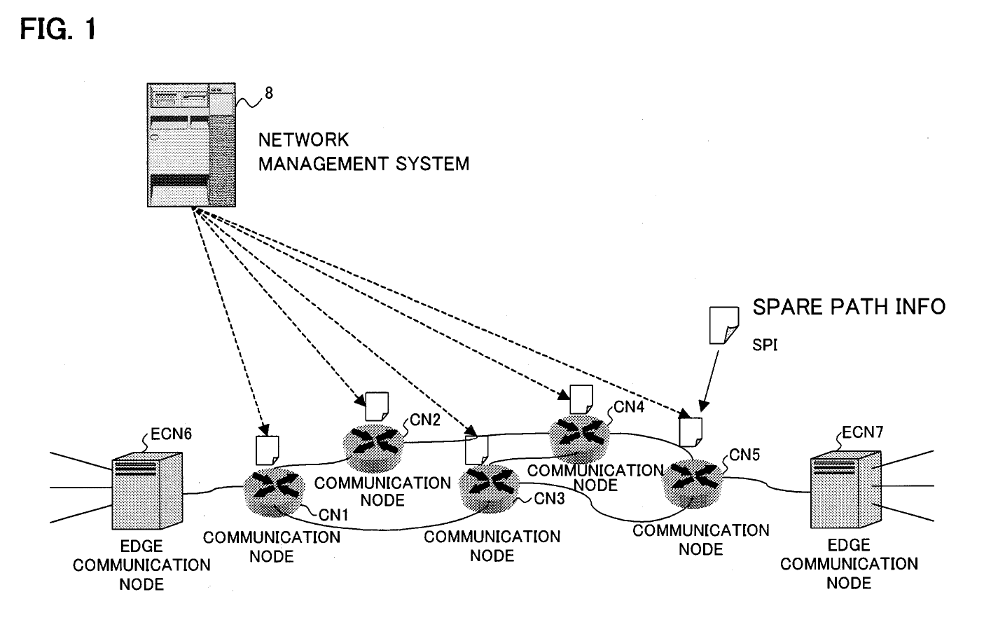

FIG. 1 shows a conceptual diagram of a communication network incorporating the spare path design method according to the present invention, and a network management system for managing the network configuration and a fault in the network.

The communication network is constituted of a plurality of mutually connected communication nodes (CN) 1-5 and edge nodes (ECN) 6, 7 functioning as an entry and exit of client signals.

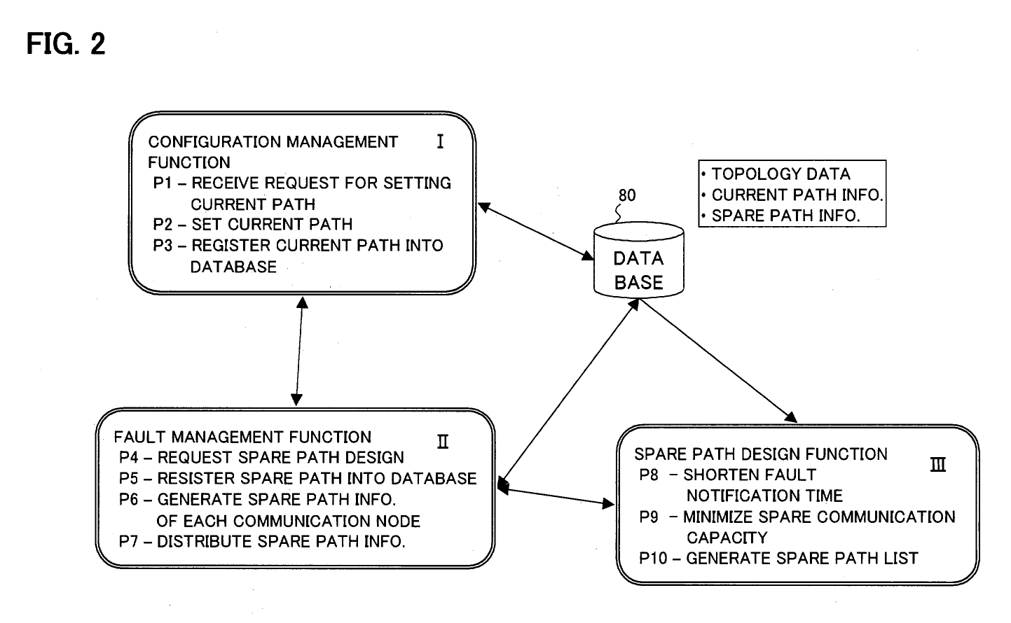

Each communication nodes 1-5 allocates spare communication resources, detects a fault, transfers a fault notification message (through the flooding method), and processes the fault notification message. Further, as shown in FIG. 2, a network management system (NMS) 8 is provided with configuration management function I, fault management function II, and spare path design function III, and stores necessary information for performing each function in a database 80.

In configuration management function I, NMS performs to receive a request for setting a current path (i.e. path in use) (procedure P1), set the current path based on a topology data stored in database 80 (procedure P2), and register the current path information set in database 80 (procedure P3).

In fault management function II, NMS performs to request spare path design for current path registered in database 80 (procedure P4) and register the obtained spare path again into the database (procedure P5). In addition, NMS generates spare path information (SPI) to be referred by each communication node (procedure P6) and distribute this information (procedure P7).

In spare path design function III, NMS performs to design spare path based on the request from fault management function II. At this time, based on the given requirement condition, fault notification time is shortened (procedure P8) and total communication resources are minimized (procedure P9). The designed spare path is reentered into fault management function II in the form of a list (procedure P10).

In each node 1-5 of the communication network, spare communication resources are allocated based on spare path information SPI distributed by network management system 8. On occurrence of a fault, NMS detects the fault to transfer a fault notification message (flooding).

On the other hand, when a node receives a fault notification message from a neighboring node, the node concerned processes this message to transfer to another node. Edge communication node 6, 7 receives a client signal and performs traffic concentration, etc. to transfer to the communication network.

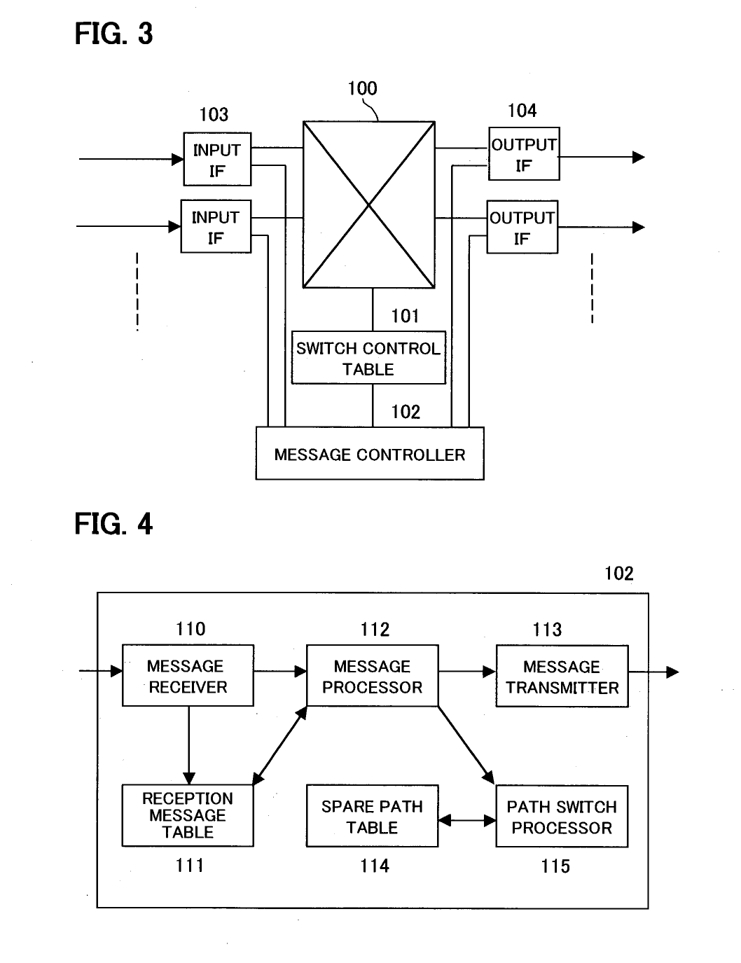

Here, FIG. 3 is an exemplary configuration block diagram of the communication node commonly applicable to each communication node 1-5. The node is constituted of input interface (IF) 103, switch 100, switch control table 101, output interface (IF) 104 and message controller 102.

Input interface 103 is constituted of one or a plurality of units, each terminating one or a plurality of transmission media (for example, optical fibers) which constitute links respectively connected to corresponding nodes, to receive a variety of data being input from a communication path included in each terminated link.

Switch 100 switches a connection condition between ports on the input interface 103 side and ports on the output interface side. For example, a unique channel number is assigned for each. port of the plurality of input interface 103 and output interface 104.

Combinations of a channel number on the input interface 103 side and a channel number on the output interface 104 side are stored in switch control table 101. Using this table, switch 100 performs routing processing for communication paths according to these combinations.

Therefore, in order to set a spare path in the event of a fault on a link or a communication path, the setting condition of communication paths in switch 100 is switched.

In output interface 104, a plurality of units are provided in a similar manner to input interface 103, to terminate one or a plurality of transmission media which constitute links respectively connected to corresponding nodes, to output a variety of data to each communication path included in the terminated link.

Message controller 102 generates a fault restoration message including fault location information on a link by link basis in the event of a fault in a link or a communication path. The generated fault restoration message is notified to other nodes by flooding.

Also, on receiving a message from a neighboring node, message controller 102 performs processing to switch to a spare path, when necessary, based on the spare path information having been set in advance in spare path table 114 by network management system 10.

FIG. 4 shows a detailed configuration of message controller 102. As shown in FIG. 4, message controller 102 includes message receiver 110, reception message table 111, message processor 112, spare path table 114, path switching processor 115 and message transmitter 113.

In message receiver 110, a message sent from a neighboring node is received. This message includes fault location information for identifying the failed link. The message received by message receiver 110 is stored in reception message table 111. In case identical messages are sent from different nodes, only one message received first is stored.

By searching in the reception completion messages stored in reception message table 111, message processor 112 verifies whether or not a new message received by message receiver 110 is duplicated with a message which has been received before.

As for a new message, message processor 112 sends an instruction to message transmitter 113 to transmit a message. Together with this, message processor 112 sends an instruction to path switching processor 115 to switch communication path connection condition by means of switch 100.

Path switching processor 115 determines whether or not the node of interest is included in the spare path according to the fault location information included in the received message. In case the node is included in the spare path, path switching processor 115 sets the spare path by rewriting the contents of switch control table 101.

Here, rewriting the contents of switch control table 101 is based on the spare path setting information corresponding to the fault location which has been set in advance in spare path table 114 by network management system 10.

The setting information is, for example, a combination of the input port channel number and the output port channel number in switch 100, which are necessary for setting the spare path corresponding to link LX, in case the node concerned is included in the spare path set in the event of a fault in link LX.

Message transmitter 113 transmits a message input from message processor 112 to neighboring nodes excluding the node from which the message is received.

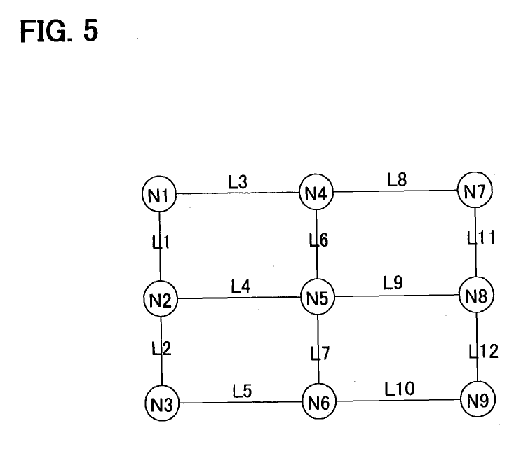

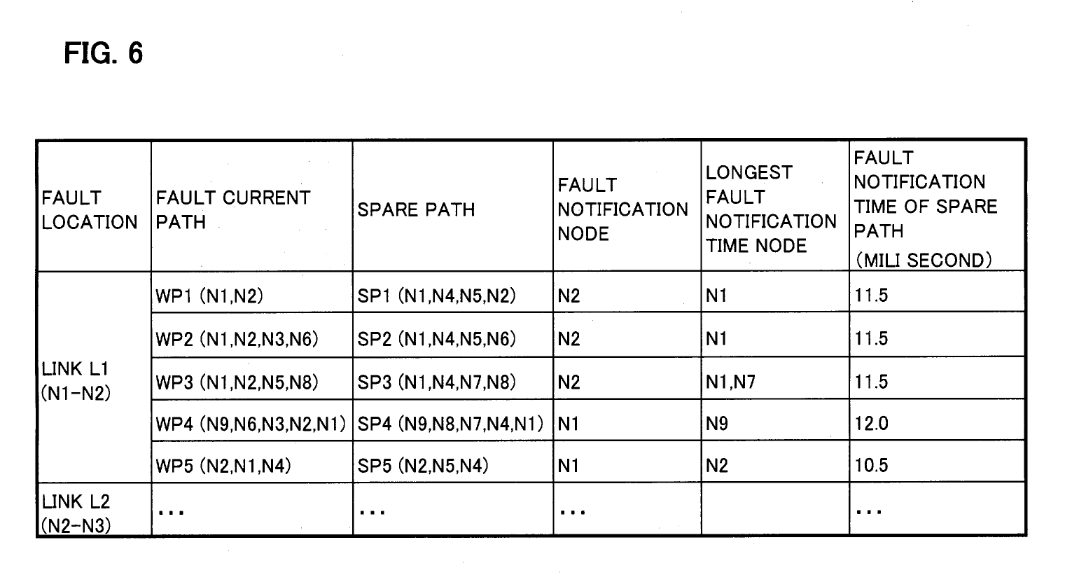

FIG. 5 shows an exemplary communication network topology as an object of the spare path design method of the present invention. N1 to N9 denote communication nodes and L1 to L12 denote communication links, respectively. FIG. 6 is an example of data structure in a spare path list (refer to FIG. 2)

This data list is transferred from spare path design function III to fault management function II in network management system 8 shown in FIG. 2. For example, as shown in FIG. 6, link L1 is a link connecting nodes N1 and N2. On occurrence of a fault on link L1, the following current paths suffer damage: WP1 (N1, N2); WP2 (N1, N2, N3, N6); WP3 (N1, N2, N5, N8); WP4 (N9, N6, N3, N2, N1); and WP5 (N2, N1, N4).

Among these paths, for example WP1 is a path initiating at N1 and terminating at N2, and one spare path SP1 is set against WP1. Here, SP1 is a path initiating at N1, passing through N4 and N5 in turn, and terminating at N2.

Further, a fault notification node in regard to WP1 is N2. Here, it is shown in FIG. 6 that a node on SP1 having the longest fault notification time from node N2 is N1 and that the time is 11.5 msec.

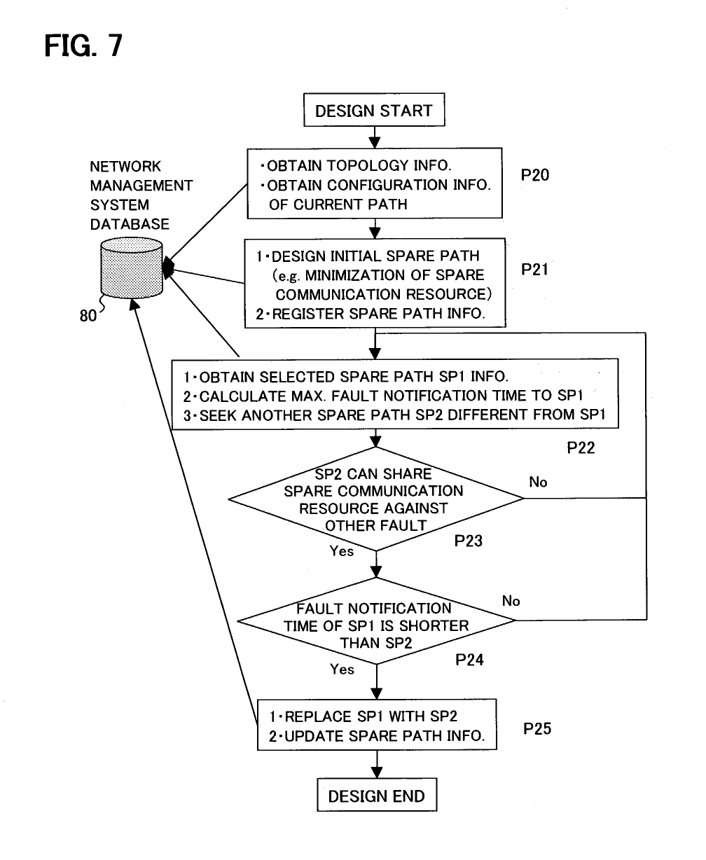

FIG. 7 shows a process flowchart of the spare path design method according to the present invention. This process is carried out in spare path design function III shown in FIG. 2. Database 80 in network management system 8 shown in FIG. 7 denotes database 80 shown in FIG. 2.

On starting the design, topology information and configuration information of current paths are obtained from database 80 (procedure P20). Thereafter an arbitrary initial spare path design including minimization of spare communication resources is performed (procedure P21-1), and the design result is registered into database 80 as an initial design value (procedure P21-2). At this time it is also possible to set this spare path information registered as the initial design value into each communication node for operation.

Next, spare path SP1 obtained by the initial design is selected (procedure P22-1) to calculate the maximum fault notification time among the nodes on SP1 (procedure P22-2). Thereafter another spare path SP2 different from spare path SP1 is sought (procedure P22-3).

Here, the time required for completing the fault notification message transmission from the node detecting a fault to the entire nodes on the spare path is obtained in the following way: To obtain each transfer time of the fault notification message from the aforementioned node detecting the fault to each node, and then to extract the maximum value among the times obtained above for the entire nodes located on the aforementioned spare path.

Thereafter, it is checked whether or not spare path SP2 can share spare communication resources against other faults (procedure P23). If the condition is satisfied, the maximum fault notification time for spare path SP1 is compared with the maximum fault notification time for spare path SP2 (procedure P24).

If the time for spare path SP2 is shorter than the time for spare path SP1, the spare path is replaced by SP2 (procedure P25-1) and the spare path information in database 80 is updated (procedure P25-2).

With this procedure it becomes possible to shorten fault notification time to communication nodes on spare path SP2 without increasing total spare communication resources. Further, it is also possible to repeat the aforementioned procedure for the entire spare paths successively.

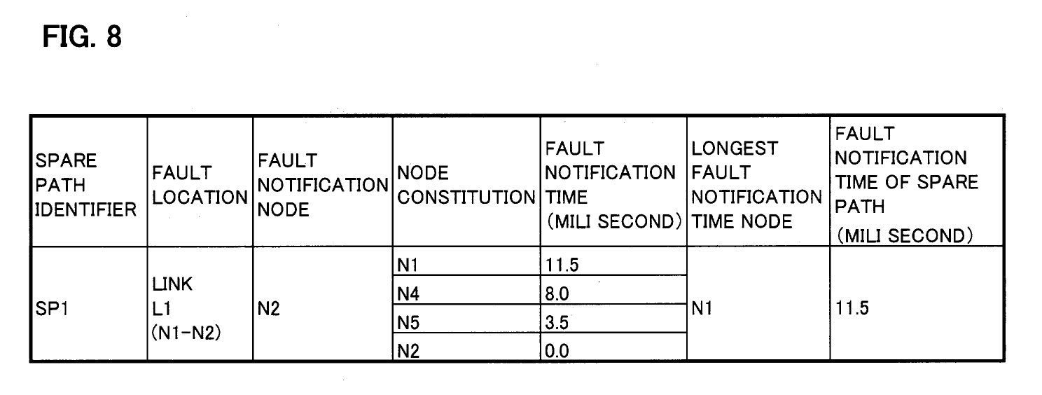

FIG. 8 shows a data structure regarding communication nodes on a spare path and data examples thereof. The data is used in FIG. 7 to obtain the maximum fault notification time among the communication nodes located on the spare path. In particular, in the column of node constitution, it is denoted that spare path SP1 is a path started from communication node N1 as an initiating point, passing through communication nodes N4, N5 in turn and completed at communication node N2 as a terminating point.

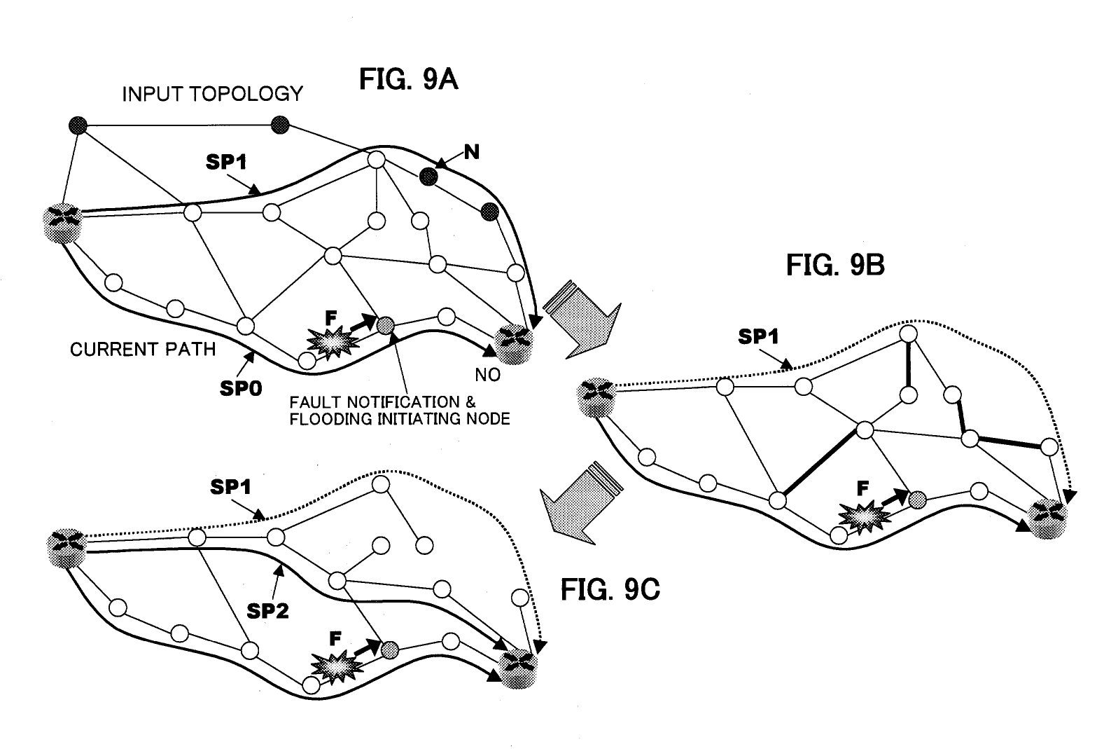

FIG. 9 illustrates a spare path update method according to FIG. 7. First, in FIG. 9A, spare path SP1 is set against fault F produced on current path SP0. There exists node N having the maximum fault notification time transmitted from fault detection node NO. Accordingly, the nodes having either an identical fault notification time or longer fault notification time compared to node N concerned (i.e. the nodes shown by black dots in FIG. 9A) are deleted from the topology data.

Further, as shown in FIG. 9B, links which are incapable of sharing spare communication resources (shown by bold lines in FIG. 9B) are deleted. Path is sought based on the topology in this condition. Accordingly, as shown in FIG. 9C, spare path SP2 having a shortened fault notification time is obtained without increasing total spare communication resources.

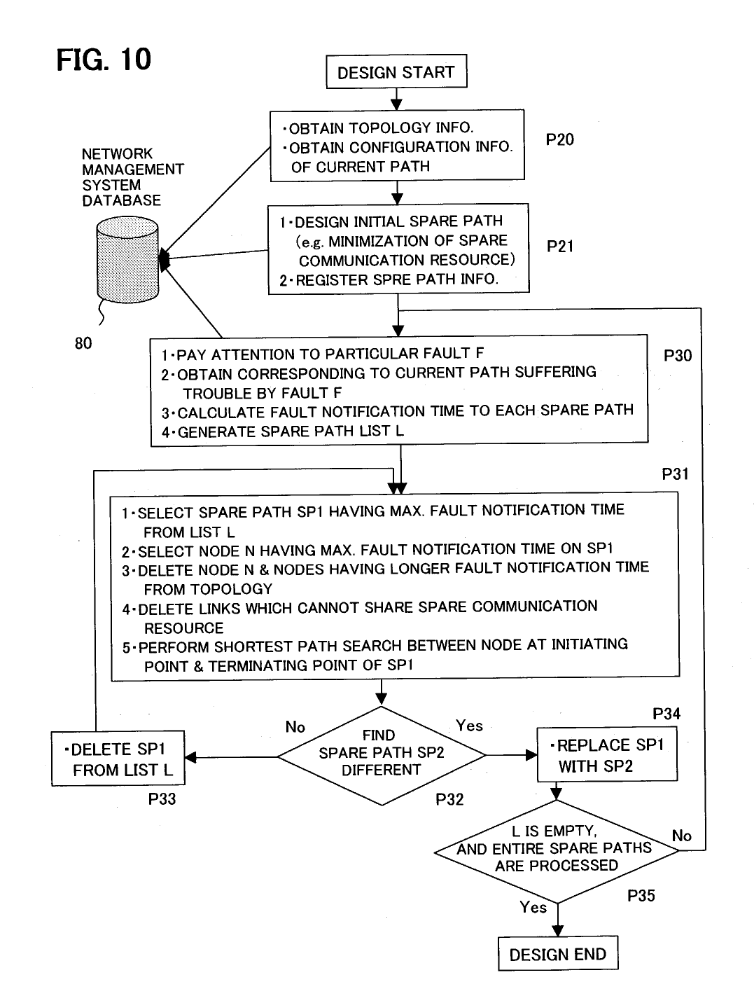

FIG. 10 shows a design process flowchart specifically illustrating the process shown in FIG. 9. Procedures P20, 21 are identical to that shown in the flowchart of FIG. 7.

In FIG. 9A, paying attention to a particular fault F (procedure P30-1), spare path information is obtained corresponding to a current path suffering trouble by fault F (procedure P30-2). Fault notification time to each obtained spare path is then calculated (procedure P30-3). Thereafter a list L such as shown in FIG. 8 is generated for each spare path (procedure P30-4).

Then, a spare path SP1 having the maximum fault notification time is selected from list L (procedure P31-1). A node N having the maximum fault notification time on the extracted spare path SP1 is selected (procedure P31-2). The selected node N and other nodes having longer fault notification time are then deleted from the topology (procedure P31-3; refer to FIG. 9A) . Further, any links which cannot share spare communication resources against other faults are deleted (procedure P31-4; refer to FIG. 9B). Thereafter the shortest path search is performed between the node at the initiating point and the node at the terminating point of the spare path SP1 selected before (procedure P31-5).

As a result of search in procedure P31-5, if a spare path, SP2 different from spare path SP1 cannot be found (No in procedure P32), spare path SP1 is deleted from list L (procedure P33) and procedures P31-1 to 31-5 are repeated.

Meanwhile, if a spare path SP2 different from spare path SP1 is found as a result of search in procedure P31-5 (Yes in procedure P32), spare path SP1 is replaced by SP2 (procedure P34). The aforementioned procedures P30, P31 are repeated for the entire spare paths in list L, and then the process is completed (Yes in procedure P35).

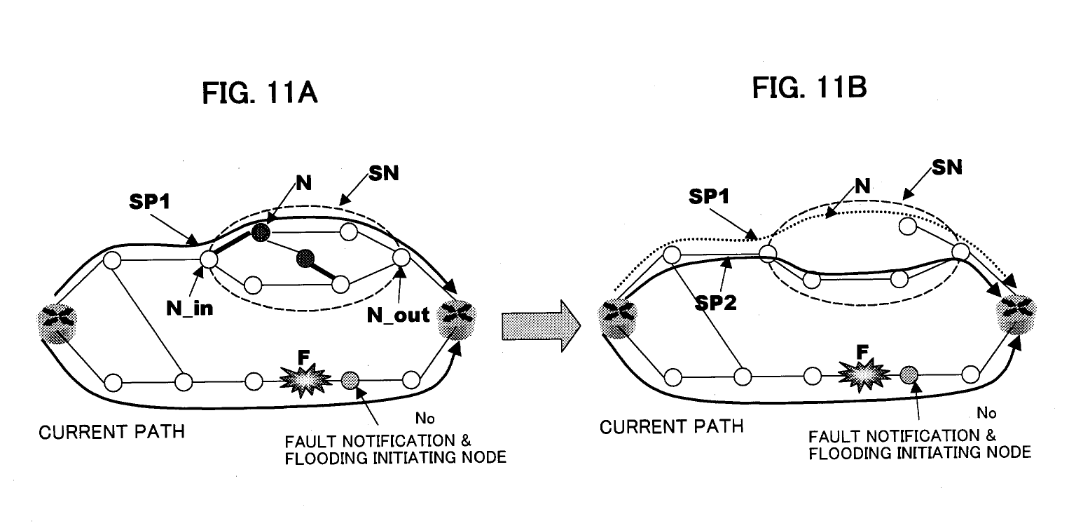

FIG. 11 shows another embodiment of the present invention, in which an update method of spare paths restricted in a subnetwork is shown. Here, subnetwork means a closed network located within links between an initiating node point and a terminating node point of which topology information is isolated

In FIG. 11A, a spare path SP1 is set against a fault F on a current path. In this figure, SN denotes a subnetwork of which the topology information is isolated. There exists a node N within subnetwork SN on spare path SP1 having the maximum fault notification time from fault detection node N0. The nodes having either an identical fault notification time to the time of node N concerned or longer fault notification time than the time of node N (i.e. nodes shown by black dots in FIG. 11A) are deleted from the topology data.

Further, links which are incapable of sharing spare communication resources (i.e. links shown by bold lines in FIG. 11A) are deleted. Spare path SP2 is then sought between entry node N#in and exit node N#out inside subnetwork SN only (FIG. 11B). In such a way, by updating to spare path SP2 only within subnetwork SN, it becomes possible to shorten fault notification time with relatively small calculation amount without increasing spare communication resources.

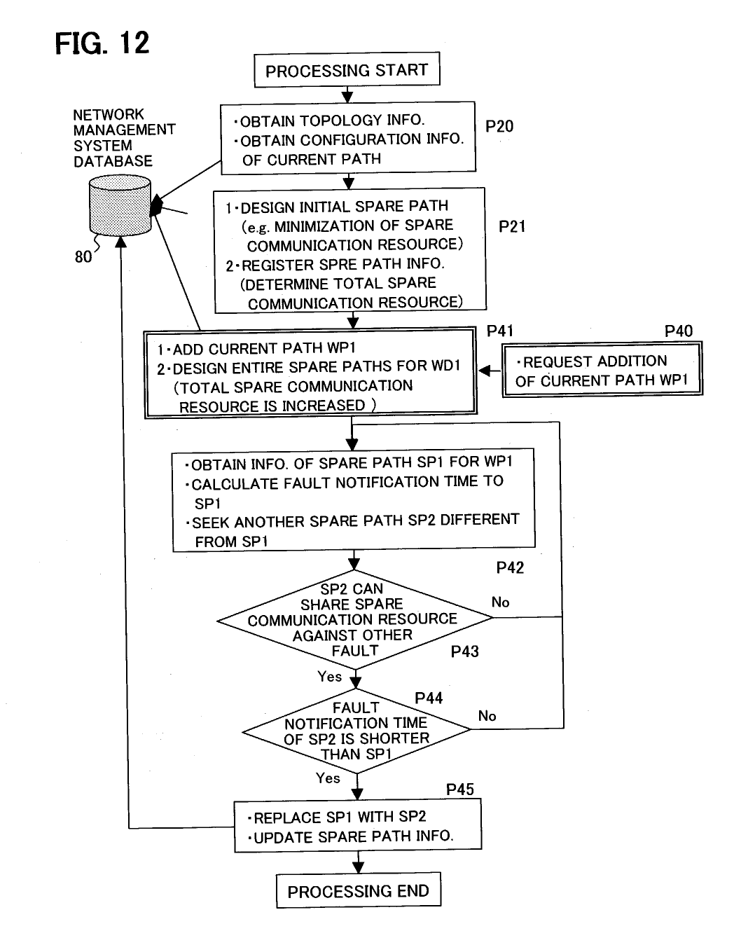

FIG. 12 is a flowchart illustrating still another embodiment of the present invention, in which a case that a request for newly adding current path WP1 is issued on demand. In FIG. 12, procedures P20, P21 are the same as the procedures shown in FIG. 10.

When addition of new current path WP1 is requested (procedure P40), the addition of current path WP1 is accepted (procedure P41-1) and entire spare paths for current path WP1 are designed (procedure P41-2). At this time, for the sake of maintaining communication, setting is not carried out and update is carried out later.

Succeeding procedures P42-P45 are the same as procedures P22-P25 shown in the embodiment example of FIG. 7 and therefore further explanation is omitted here.

In this embodiment, it is possible for any spare path set against the added current path WP1 to share spare communication resources (Yes in procedure P43) and therefore to update to a spare path having shorter fault notification time without increasing total spare communication resources (Yes in procedure P44).

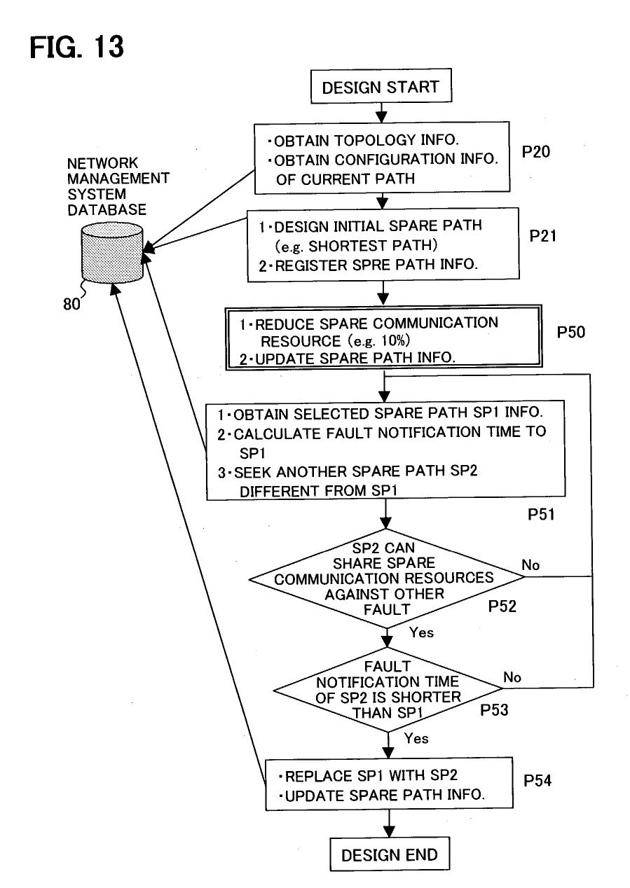

FIG. 13 is still another embodiment according to the present invention. There is shown a flowchart illustrating processing that a spare path is updated from an arbitrary initially designed spare path so as to reduce a certain rate of communication resources, and thereafter the spare path capable of sharing spare communication resources without increasing total spare communication resources is obtained and updated.

In FIG. 13, procedures P20, P21 are the same as the corresponding procedures formerly shown in FIGS. 7, 10. Thereafter, from an arbitrary spare path initially designed, a certain rate, for example 10%, of spare communication resources are reduced (procedure P50-1) to update the spare path (procedure P50-2). Here, the processing for reducing spare communication resources is performed under an arbitrary reduction program.

Next, a spare path SP1 is selected from among spare paths of which spare communication resources are to be reduced (procedure P51-1), to calculate the maximum fault notification time among the nodes on SP1 (procedure P51-2). Thereafter a spare path different from spare path SP1 is sought (procedure P51-3).

Then, regarding spare path SP2, whether or not the spare communication resources can be shared against other faults is checked (procedure P52). When the condition is satisfied, the maximum fault notification time is compared between the nodes on spare path SP2 and the nodes on spare path SP1 (procedure P53).

If the time for spare path SP2 is shorter, the spare path is replaced by spare path SP2 (procedure P54-1) to update spare path information in database 80 (procedure P54-2).

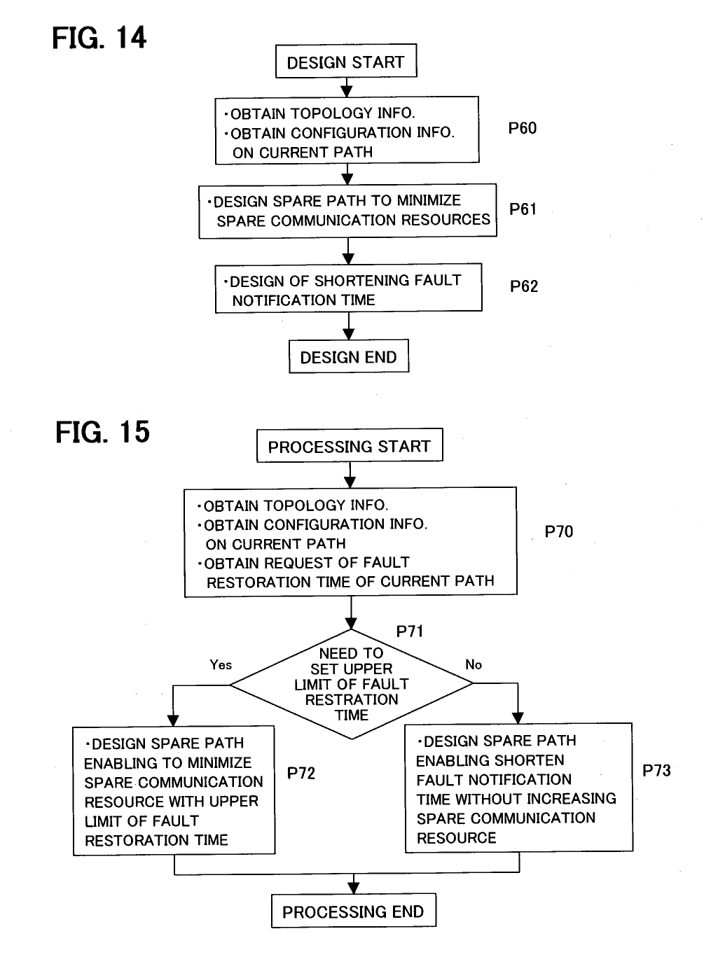

FIG. 14 shows still another embodiment of the present invention. When the design is started, topology information and configuration information on current path are obtained from database 80 (procedure P60). Then, spare path design is performed so as to minimize spare communication resources (procedure P61). Thereafter an index is modified to obtain a spare path which is capable of sharing spare communication resources and at the same time the spare communication resources are not increased through the procedure illustrated before in FIG. 7 (procedure P62).

Here, it is also possible to determine a request of fault restoration time for the set current path and to select a design method corresponding to the requested restoration time. FIG. 15 shows a flowchart illustrating this method.

In FIG. 15, for the sake of initial setting, the topology information and configuration information on current path are obtained in a similar manner to procedure P20 in the flowchart shown in FIG. 7, and also the request of the fault restoration time is obtained (procedure P70).

Thereafter, if it is necessary to set an upper limit against the request of fault restoration time for this current path (Yes in procedure P71), a spare path enabling to minimize the total communication resources with the upper limit of fault restoration time is designed (procedure P72) in accordance with a method having been disclosed by the inventors of the present invention (in the Japanese Patent Application No. Hei-13-80087).

To the contrary, if there is no upper limit set against the aforementioned request of fault restoration time for the current path (No in procedure P71), a spare path is designed enabling to shorten fault notification time without increasing spare communication resources (procedure P73).

The foregoing description of the embodiments is not intended to limit the invention to the particular details of the examples illustrated. Any suitable modification and equivalents may be resorted to the scope of the invention. All features and advantages of the invention which fall within the scope of the invention are covered by the appended claims.

What is claimed is:

1. A spare path design method for a communication network in which spare path information is set in advance in each node of the communication network constituted of a plurality of nodes based on a database, a fault notification message including fault location information is transferred from a fault detection node to each node when a link fault or a node fault occurs, and the nodes receiving the fault notification message switch the path in parallel, the spare path design method comprising the steps of:
selecting a first spare path obtained by an initial design to obtain among nodes located on the first spare path a node having the maximum fault notification time from the fault detection node;
seeking a second spare path different from the first spare path;
examining whether or not the second spare path can share spare communication resources against other faults, and comparing the maximum fault notification time among the nodes located on the second spare path with the maximum fault notification time among the nodes located on the first spare path when the resource sharing condition is satisfied; and
as a result of the comparison, if the time in the second path is shorter, replacing the spare path by the second spare path to update spare path information stored in the database.

2. The spare path design method according to claim 1, wherein a time for completing to transfer fault notification messages from the fault detection node to the entire nodes located on a spare path is calculated by obtaining a transfer time of the fault notification message from the fault detection node to each node and then obtaining the maximum value among the time values calculated for the entire nodes located on the spare path.

3. The spare path design method according to claim 1 further comprising the step of:
when seeking a second spare path different from the first spare path, omitting the node located on the first spare path having the maximum fault notification time, nodes having longer fault notification time than the maximum fault notification time, and links which are incapable of sharing spare communication resources against other faults.

4. The spare path design method according to claim 1 further comprising the step of:
when the node located on the first spare path having the maximum fault notification time exists inside a certain isolated domain, seeking another spare path between an entry node and an exit node of the domain which passes through neither the node on the first spare path having the maximum fault notification time, nodes having longer fault notification time than the maximum fault notification time, nor links which are incapable of sharing spare communication resources against other faults.

5. The spare path design method according to claim 3, further comprising the step of:
when the node located on the first spare path having the maximum fault notification time exists inside a certain isolated domain, seeking another spare path between an entry node and an exit node of the domain which passes through neither the node on the first spare path having the maximum fault notification time, nodes having longer fault notification time than the maximum fault notification time, nor links which are incapable of sharing spare communication resources against other faults.

6. The spare path design method according to claim 1, further comprising the steps of:
for a current path newly required to add, setting both the current path required to add and an arbitrary spare path; and
thereafter, for the arbitrary spare path, updating to a spare path which is capable of sharing spare communication resources against a different fault and transferring the fault notification message from the fault detection node in a shortened time without increasing spare communication resources.

7. The spare path design method according to claim 1, further comprising the steps of:
designing a spare path capable of reducing a certain rate of total spare communication resources against the first spare path previously set; and
thereafter, for the spare path reducing the total spare communication resources, updating to a spare path which is capable of sharing spare communication resources against a different fault and transferring the fault notification message from the fault detection node in a shortened time without increasing spare communication resources.

8. The spare path design method according to claim 1 ,wherein as the initial design, a spare path design for minimizing a spare communication capacity is performed.

9. The spare path design method according to claim 7, wherein as the initial design, a spare path design for minimizing a spare communication capacity is performed.

10. The spare path design method according to claim 1, wherein when setting a strict upper limit to a fault restoration time is required, the design method selects a method including the steps of:
seeking a spare path having the minimum transfer time of fault notification message; and
then, updating to a spare path which is capable of sharing spare communication resources against a different fault and switching a path within a given upper time limit.

11. The spare path design method according to claim 6, wherein when setting a strict upper limit to a fault restoration time is required, the design method selects a method including the steps of:
seeking a spare path having the minimum transfer time of fault notification message; and
then, updating to a spare path which is capable of sharing spare communication resources against a different fault and switching a path within a given upper time limit.
